(19) United States
(12) Patent Application Publication
(10) Pub. No.: US 2008/0151543 A1
(43) Pub. Date: Jun. 26, 2008

(54) Ultra thin power led light with heat sink

(76) Inventor: Xiaoping Wang, Shanghai (CN)

Correspondence Address: LAW OFFICES OF CLEMENT CHENG, 17220 NEWHOPE STREET #127, FOUNTAIN VALLEY, CA, 92708, US

(21) Appl. No.: 12/072,997

(22) Filed: Feb. 29, 2008

Related U.S. Application Data
(63) Continuation-in-part of application No. 11/408,715, filed on Apr. 21, 2006.

(51) Int. Cl. F21V 21/00; F21V 7/00

(52) U.S. Cl. 362/240; 362/241

(57) ABSTRACT

An LED light with heat sink is formed from a metal board with holes for mounting lens and reflective cavities inside the metal board, and within the cavities, multiple LED chips are mounted, and with a PCB board on the top of the metal board. One wire pair is connected to an LED light to form external power supply wires. Small holes on the PCB are to mount the lens and the big hole is to let the light through. The LED chips are mounted directly on metal board functioned as heat sink in electrical connection with the wire pairs makes an ultra thin, high brightness, and low cost Power LED Light. The reflective cavities may have single or multiple chips mounted inside with the chips directly mounted on the metal board within the reflective cavity.

This application is a continuation in part of and claims priority from U.S. application for inventor Wang, Xiaoping Ser. No. 11/408,715 Multi Chip LED Lamp filed Apr. 21, 2006, the disclosure of which is incorporated herein by reference in its entirety.

### BACKGROUND OF THE INVENTION

Powered LED light can be used in illuminated signs, with the advantages of environmental friendliness and energy savings, but LED cannot transfer all the electrical power into light power, so power LED emits heat while emitting light, which leads to heat dissipation as one of the prime difficulties within the industry. The existing technology is to mount the encapsulated LED to an extra heat sink to dissipate the heat, and some adopt the method of fan cooling technology. Unfortunately, such methods are inefficient and do not effectively release the heat of the LED chip, and as a result, the volume and mass of the heat sink keeps increasing, and the cost of the heat sink increases. Inefficient heat transfer therefore makes LED light devices less environmentally friendly. Other deficiencies such as low efficiency and inconvenient applications still exist, which keeps the LED light inapplicable in small sized illuminated signs.

### SUMMARY OF THE INVENTION

The object of this invention is to create an environmentally friendly LED light apparatus that uses less material, but has generous thermal tolerances and highly efficient heat transfer.

To solve the technical defects, this invention of ultra thin Power LED light with the solution of heat sink is made of a metal board with holes for mounting lens and reflective cavities inside the metal board, and within the cavities, multiple LED chips are mounted, and with a PCB board on the top of the metal board. One wire pair is connected to an LED light to form external power supply wires. Small holes on the PCB are to mount the lens and the big hole is to let the light through. The LED chips are mounted directly on metal board functioned as heat sink in electrical connection with the wire pairs makes an ultra thin, high brightness, and low cost Power LED Light. Therefore, the present invention is a lamination of a metal board with a PCB board. Lamination and bonding can be by a variety of commonly known techniques such as use of adhesive, or mechanical connection such as screws or staples. Alternatively, the PCB and metal board can be separated so that there are two separate parts where there is a space or gap between the PCB and the metal board.

### BRIEF DESCRIPTION OF THE DRAWINGS

The following drawings are described below as follows:

FIG. 1 is a theoretical circuit diagram showing the present invention.

FIG. 2 is a side cross section view.

FIG. 3 is a top view of the PCB.

FIG. 4 is a top view of the metal board.

FIG. 5 is a diagram showing of the LED Chips connection.

The following club list of elements may be helpful in understanding the drawings:
1. Metal Board
2. PCB Board
3. Electrical Leads of PCB
4. Insulated Layer of PCB
5. Holes for Mounting Lens
6. Big hole for LED light through
7. Reflective Cavities in Metal Board
8. LED Chips
9. Connection thread between LED Chips
13. Wires
14. Wire Clipper
15. Fixing Holes
131. Lens

### DETAILED DESCRIPTION OF THE PREFERRED EMBODIMENT

FIG. 1 illustrates a theoretical circuit diagram showing of the present invention, which is the most common structure of the invention. As it is shown in FIG. 1, the shape of the LED light can be shaped as a rectangular piece, or shapes as square, circle, and diamond. The PCB 2 is mounted on the metal board 1, and the PCB is smaller in size than the metal board so as to make heat transfer better and provide space to fix the wires. The electrical leads 3 on the PCB are connected to power supply wires 10, 11, 12, 13, and also connected metal thread 9 (preferably gold line) and LED chips 8 are connected by metal thread 9 (preferably gold line) and the LED chips are connected to the external power supply. The metal thread 9 is an intermediate wire connection connecting LED chips 8. When the LED chips are set in the reflective cavities, the light can be reflected so as to increase the light emitting efficiency. The reflective cavities are parabolic shaped. The LED chips can be mounted in the reflective cavities; or all chips being mounted in one big reflective cavity. LED chips 8 are mounted directly on the metal board within the reflective cavities so as to transfer the heat of the LED chips to the heat sink or the metal board, which increases the heat transfer and decreases the size of the heat sink. This differs from the traditional method of encasing the LED chips with resin epoxy to make LED lamps and then mounting the LED lamps with a metal heat sink, because due to the resin, it would prevent efficient heat transfer. The big hole 6 on the PCB is to let the LED light through, and small holes 5 are to mount lens to protect the LED chips of the LED light and line connects from outside damage. The wire clippers 14 are to fix the wires connect to external power supply.

The PCB and the metal heat sink board are adopted with the shape of a flat and thin sheet so as to make it different from other LED lights, and with ultra thin design, the LED light can be set to illuminate comparatively smaller signs without leaving light spots on the surface of the sign. The metal board is bigger in size than the PCB and in this way to make part of the metal board exposed to the air and therefore, the efficiency of the heat sink increases.

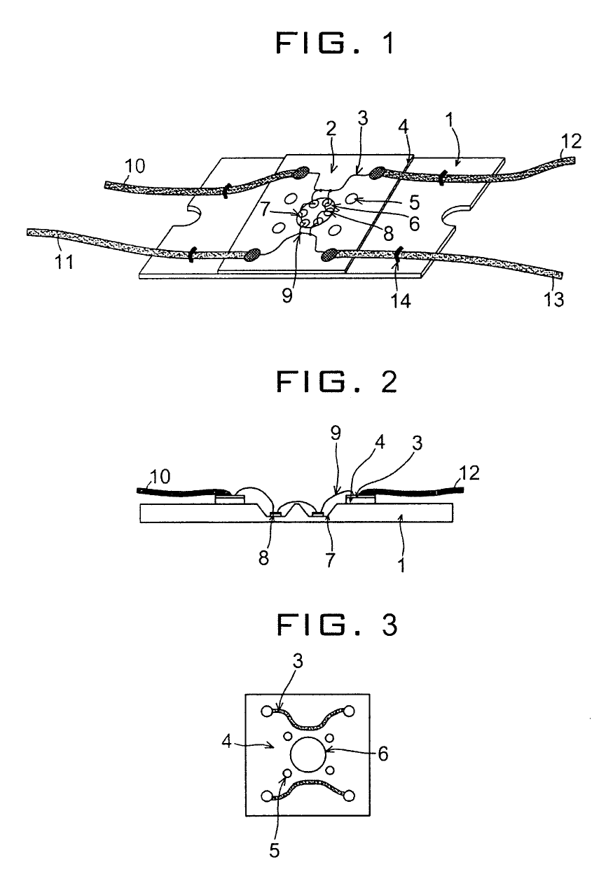

FIG. 2 is a side cross section view of the invention. As it is shown, LED chips 8 connect to electrical leads 3 on the PCB through gold thread 9, and through the connections to external power supply wires 10, 12 to light the LED light up. From FIG. 2, it can be seen that the LED chips are mounted directly in the reflective cavities within the metal board, and the heat of the LED chips being transferred to the air through the metal board and increasing the efficiency of the heat sink. The PCB has only wire connections on the top face and not on the bottom face which is in direct contact with metal sheet below. The PCB has an opening surrounding the LED chips. The opening is circular as shown in FIG. 1, but can also be made in a variety of other shapes. The circular opening allows mounting of six chips as shown in FIG. 1. Alternatively, the chips can be mounted adjacent to the PCB.

FIG. 3 is the top view of the PCB. As it is shown, a big hole 6 lets the light through and small holes 5 allow a user to mount the lens. The electrical leads on the board is for connecting the LED chips to the external power supply.

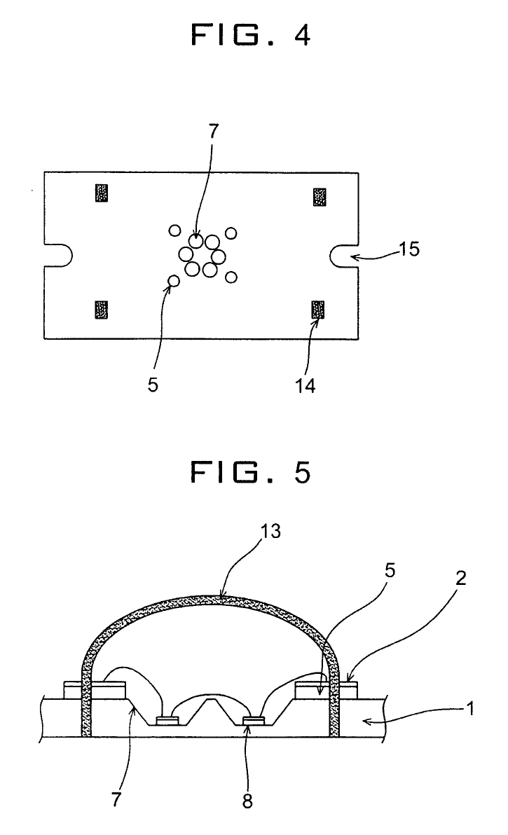

FIG. 4 is the top view of the metal board. As it is shown, the holes 5 are to mount lens, and cavity 7 are reflective cavities, comprising of a total of six small cavities. Alternatively, the reflective cavity can be a single one. The wire fixer 14 is part of the metal board, which is preferably integrally formed by a punching press. The wire clipper 14 is easy to operate and with low cost. The fix hole 15 or mounting hole 15 provides the user a more convenient mounting of the LED light, such as by screws.

FIG. 5 is the side view of the LED light with lens on. The lens fixing supports 131 go through holes 5 on PCB and metal board holes 5 and functioning as the protector of the LED chips. Because there is an air gap formed, the lens does not need to be airtight. The lens mounting can be made of any material that optical lens are typically made of such as glass or polycarbonate.

1. An LED light comprising:
a metal board;
reflective cavities formed an a top surface of the metal board;
multiple LED chips mounted in the reflective cavities;
intermediate wire connections connecting the multiple LED chips;
a PCB mounted on the top of the metal board; and
at least one wire pair connected to the LED light to form external power supply wires.

2. An LED light of claim 1, wherein the metal board is flat and rectangular in shape.

3. An LED light of claim 2, wherein the wire clipper is a part of the metal board for securing the wires.

4. An LED light of claim 2, wherein at least one material of the metal board is aluminum.

5. An LED light of claim 1, wherein the metal board has one or more reflective cavities, and wherein the cavity has a flat bottom portion.

6. An LED light of claim 1, wherein the reflective cavities are with single or multiple chips mounted inside and the chips are directly mounted on the metal board within the reflective cavity.

7. An LED light of claim 6, wherein the LED chips which are mounted on the metal board in the reflective cavities are connected in series or parallel connection or mix connection and are connected to the same power supply through electrical leads.

8. An LED light of claim 6, wherein the chips are different colors.

9. An LED light of claim 1, wherein the PCB contains the electrical circuits and an insulated layer and wherein the PCB further comprises a big hole to let the light through and wherein the PCB further comprises small holes to mount the lens.

10. An LED light of claim 1, wherein the PCB and the metal board are two separate parts where there is a space between the PCB and the metal board and wherein the PCB is smaller than the metal board in size.

11. An LED light of claim 1, wherein the metal board is with one or more reflective cavities, and the cavity is bowl shaped.

12. An LED light of claim 11, wherein the metal board is with one or more reflective cavities, and the cavity is parabolic shaped.

13. An LED light of claim 12, wherein the PCB and the metal board are two separate parts where there is a space between the PCB and the metal board and wherein the PCB is smaller than the metal board in size.

14. An LED light of claim 13, wherein the metal board has one or more reflective cavities, and wherein the cavity has a flat bottom portion.

15. An LED light of claim 14, wherein the metal board is flat and rectangular in shape.

16. An LED light of claim 15, wherein the reflective cavities are with single or multiple chips mounted inside and the chips are directly mounted on the metal board within the reflective cavity.
